(19) United States
(12) Patent Application Publication
(10) Pub. No.: US 2007/0103922 A1
(43) Pub. Date: May 10, 2007

(54) Illuminated vehicle identification sign

(76) Inventors: H. Bradford Rissmiller, Telford, PA (US); Clifford Whynott, Beverly, MA (US)

Correspondence Address: LITMAN LAW OFFICES, LTD., P.O. BOX 15035, CRYSTAL CITY STATION, ARLINGTON, VA, 22215, US

(21) Appl. No.: 11/543,966

(22) Filed: Oct. 6, 2006

Related U.S. Application Data
(60) Provisional application No. 60/735,209, filed on Nov. 10, 2005.

(51) Int. Cl. B60Q 1/56

(52) U.S. Cl. 362/499; 362/503; 362/540; 362/542

(57) ABSTRACT

The illuminated vehicle identification sign is an apparatus having an EL panel powered up by a dc to ac inverter. Adhered to the EL panel is a white translucent vinyl first overlay. A black opaque high performance vinyl second overlay is adhered to the white translucent vinyl. The black opaque second overlay has a plurality of patterned cutouts and patterned fills. A plurality of blue translucent vinyl patterns depicting text is adhered to the white translucent vinyl and is fits inside of the plurality of patterned cutouts and outside of the plurality of patterned fills with a gap between the pattern and the fill.

### CROSS-REFERENCE TO RELATED APPLICATION

This application claims the benefit of U.S. Provisional Patent Application Ser. No. 60/735,209, filed Nov. 10, 2005.

### BACKGROUND OF THE INVENTION

1. Field of the Invention

The present invention relates to vehicle identification signs, and more particularly, to custom, illuminated vehicle identification signs.

2. Description of the Related Art

Electroluminescent (EL) signage has been around for years and is widely popular because of the relatively long life and brilliance of the electroluminescent light source of the signage. EL vehicle signage is gaining in popularity due to the light weight and low power consumption of the signs.

To date, the vehicle signs, however, have only been of a one-dimensional appearance, not having the brilliant and contrast-laden text and numerals desirable in for example, police cars and fire engines. It is particularly important that unmarked police and fire vehicles have some identification markings/and or text that is discretely low profile, only to be highly visible when desired by the public safety personal operating the vehicle. Incandescent and discharge lamps having enclosing envelopes are for the most part spherical or tubular, generally having large diameters.

Additionally, non-EL lamps use intense light sources that must have lenses, reflectors, and the like to focus the generated light for the purpose of creating an illuminated sign. Therefore the incandescent and discharge lamps are not desirable for the aforementioned application.

World Patent No. WO 93/04568, issued to Knoll et al. on Mar. 4, 1993 uses an EL optronic device for heads up display of information on a windshield. Yet, the Knoll invention does not appear to disclose a complex overlay of materials on top of the EL source to produce vibrant and easily seen vehicle identification signs. Similarly, French Patent No. FR 2738783, issued to Sayer Olivier, on Mar. 21, 1997 discloses electroluminescent diodes fitted inside of a windshield but does not appear to disclose a complex overlay of materials on top of the light source to produce vibrant and easily seen vehicle identification signs.

Until the present invention, there has been no sophisticated pattern and overlay system to fully capitalize on the advantages of EL lighting as a source for vehicle identification signage.

Hence, there remains a need for an illuminated vehicle identification sign with illumination characteristics of high contrast, high resolution and high visibility when powered up, and discrete visibility when not powered up.

Thus, an illuminated vehicle identification sign solving the aforementioned problems is desired.

### SUMMARY OF THE INVENTION

The illuminated vehicle identification sign is an apparatus having an EL panel powered up by a dc to ac inverter. Adhered to the EL panel is a white translucent vinyl first overlay. A black opaque high performance vinyl second overlay is adhered to the white translucent vinyl.

The black opaque second overlay has a plurality of patterned cutouts and patterned fills. A plurality of blue translucent vinyl patterns depicting text is adhered to the white translucent vinyl and is adapted to fitting inside of the plurality of patterned cutouts and outside of the plurality of patterned fills.

Each of the translucent vinyl patterns adapted to fitting outside of the patterned fills has a gap between the translucent vinyl pattern and the black opaque pattern fill. Each of the translucent vinyl patterns adapted to fitting inside of the patterned cutouts has a gap between the translucent vinyl pattern and the patterned cutout.

These and other features of the present invention will become readily apparent upon further review of the following specification and drawings.

### BRIEF DESCRIPTION OF THE DRAWINGS

FIG. 1 is an environmental, perspective view of an illuminated vehicle identification sign according to the present invention.

FIG. 2A is an exploded, perspective view of a first embodiment an illuminated vehicle identification sign of the present invention.

FIG. 2B is a front view of the sign of FIG. 2A.

FIG. 3A is an exploded, perspective view of a second embodiment an illuminated vehicle identification sign of the present invention.

FIG. 3B is a front view of the sign of FIG. 3A.

FIG. 4A is an exploded, perspective view of a third embodiment an illuminated vehicle identification sign of the present invention.

FIG. 4B is a front view of the sign of FIG. 4A.

FIG. 5 is a diagrammatic view of the power source and connection to the EL panel an illuminated vehicle identification sign of the present invention.

Similar reference characters denote corresponding features consistently throughout the attached drawings.

### DETAILED DESCRIPTION OF THE PREFERRED EMBODIMENTS

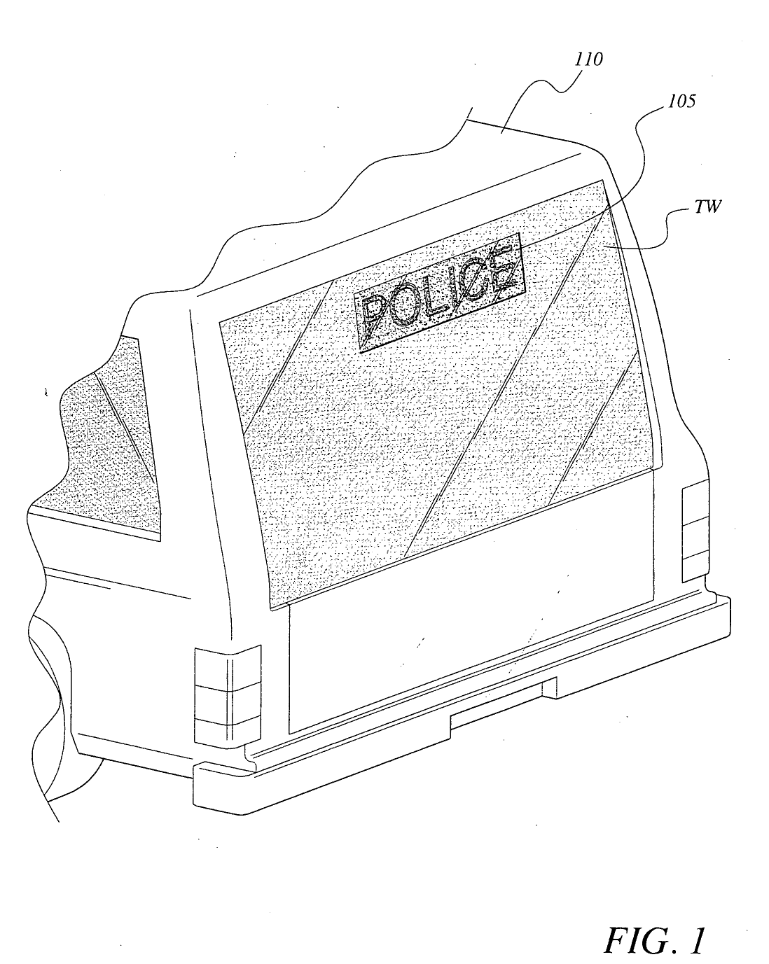

As shown in FIG. 1, the present invention is an illuminated vehicle identification sign 105, preferably adapted for displaying vehicle ID through a tinted window TW of a police vehicle 110.

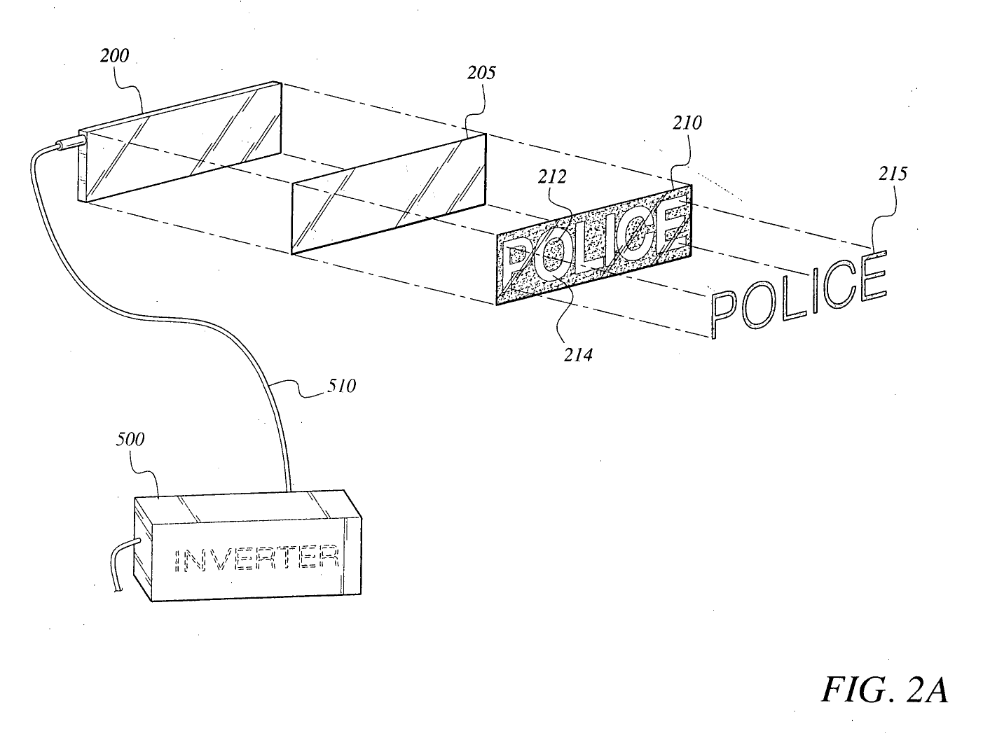

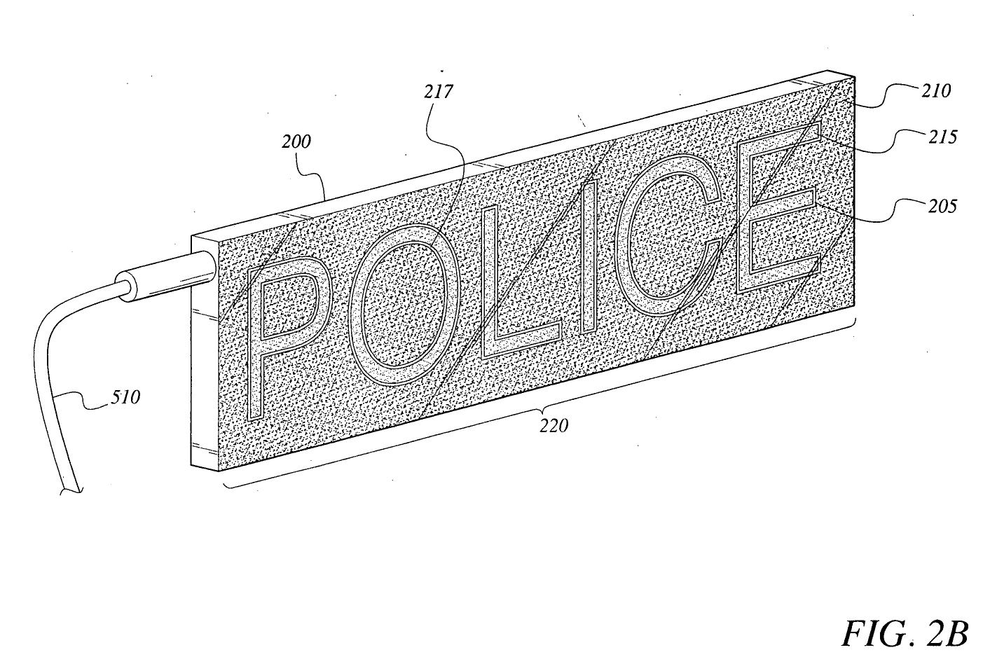

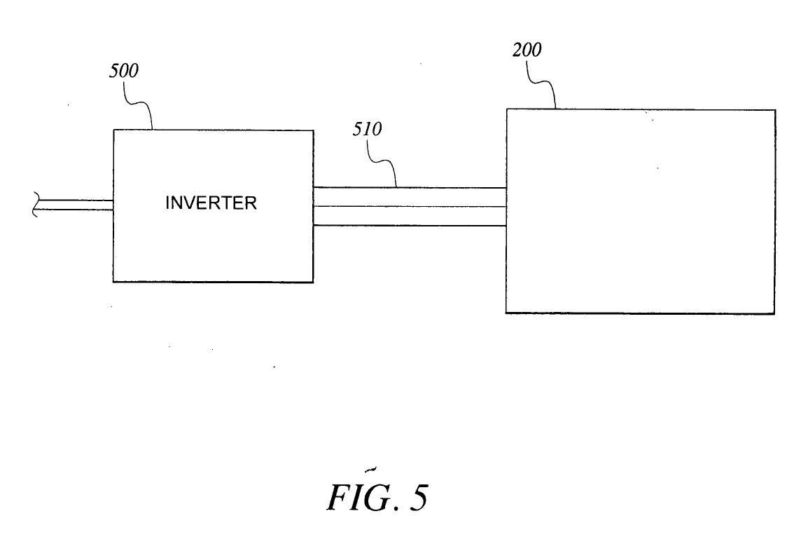

As shown in FIG. 5, the present invention comprises a rectangular shaped electroluminescent, (EL), panel 200 powered up by a DC to AC inverter 500, connected to EL panel 200 via a wire or cable 510. Although in the embodiment shown the EL panel 200 is rectangular, as contemplated by the present invention, the EL panel 200 can have any shape. The EL panel produces a non-glare light which does not “halo” in bad weather. Preferably the EL panel 200, as shown in FIG. 2A, is comprised of a capacitor structure having a plurality of electrodes with phosphor sandwiched between the electrodes, i.e., a light emitting capacitor, (LEC). Rectangular shaped EL panel 200 has preferable dimensions of, but not limited to, twenty-four inches by four inches, and may have a thin profile, e.g., only 9/10 mm thick. Preferably, the DC to AC inverter 500 is capable of inverting an approximate 12-volt DC input to an approximate 170-volt RMS AC output having an approximate frequency of 1,200 Hz. Maximum DC input current is approximately 1,200 mA. Inverter 500 may also have an On/Off flash capability of two seconds on time versus one second off time. The inverter 500 may also have a light dimmer control to provide an adjustment of a light intensity of EL panel 200. Advantageously, when the EL panel 200 is powered off, the vehicle sign 105 can still appear as a traditional decal during daylight hours.

As shown in FIG. 2A, adhered to the EL panel 200 is a white translucent vinyl first overlay 205, preferably having an adhesive manufactured on a back side to facilitate adhesion. A black opaque high performance vinyl second overlay 210 is adhered to the white translucent vinyl 205. The black opaque second overlay preferably has an adhesive manufactured on a back side to facilitate the adhesion. The black opaque second overlay 210 has a plurality of patterned cutouts 214 and patterned fills 212.

A plurality of blue translucent vinyl patterns 215 depicting text is adhered to the white translucent vinyl 205 and is adapted to fitting inside of the plurality of patterned cutouts 214 and outside of the plurality of patterned fills 212. The plurality of blue translucent vinyl patterns 215 preferably has adhesive manufactured on its back to facilitate adhesion.

Each of the translucent vinyl patterns 215 adapted to fitting outside of the patterned fills 212 has a gap 217, i.e., space or contour between the pattern 215 and the fill 212. Each of the translucent vinyl patterns 215 adapted to fitting inside of the patterned cutouts 214 has a gap 217, i.e., space or contour between the translucent vinyl pattern 215 and the patterned cutout 214.

As shown in FIG. 2B, when powered on, the overlays 205, 210 in combination with the blue translucent patterns 215 result in a brilliant, high visibility illuminated vehicle identification sign 220 having a white border created by the gap, and a black fill color from the black overlay 210.

A manner of making the aforementioned sign 220 comprises cutting out the white translucent vinyl overlay 205 in the form of a rectangle and applying wet, centered on the EL panel 200. Excess water is squeegeed out. Next, the patterned cutouts 214 and patterned fills 212 are cut out in black vinyl to form the black vinyl overlay 210. The patterned cutouts 214 and patterned fills 212 of the overlay 210 are applied wet and centered on the white translucent vinyl overlay 205. Excess water is squeegeed out. Subsequently, the plurality of blue translucent vinyl patterns 215 are cut out to depict text or logo, and applied wet and centered about the black vinyl patterned cutouts 214 and the black vinyl patterned fills 212 while maintaining a space, i.e., contour of preferably 0.25 inches inside of the patterned cutouts 214, and maintaining a space, i.e., contour of preferably 0.25 inches outside of the patterned fills 212 so that the gap 217 exposes a white outline, i.e., white border between the text or logo and the patterned cutouts 214 and the patterned fills 212. Again, excess water is then squeegeed out. Excess vinyl is then trimmed to edges of the EL panel 200.

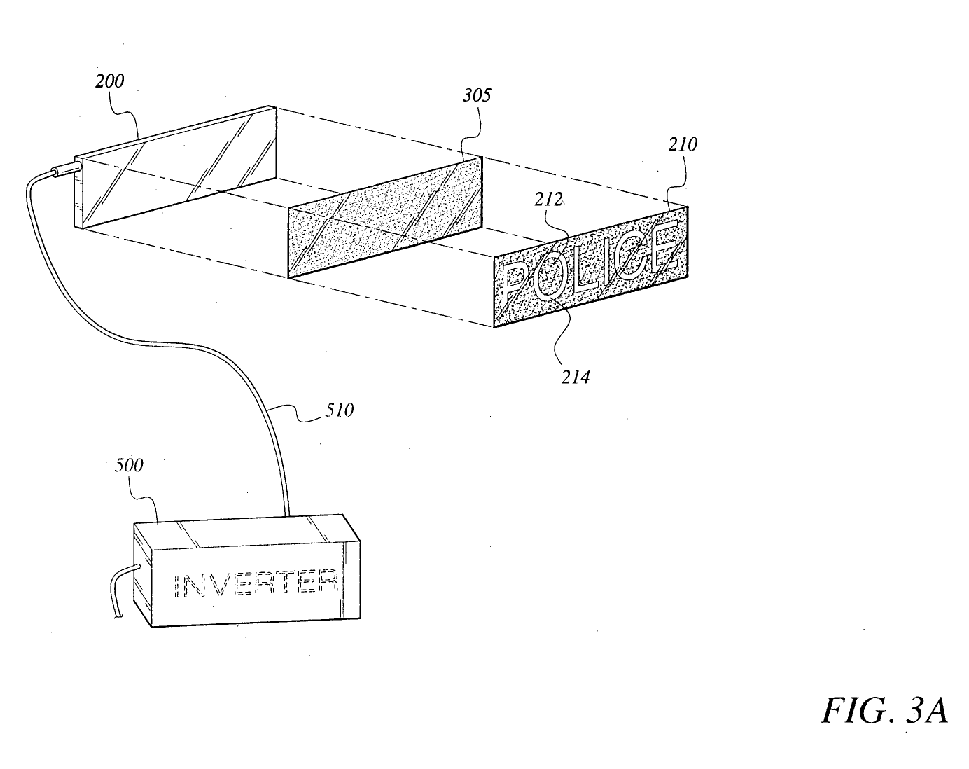

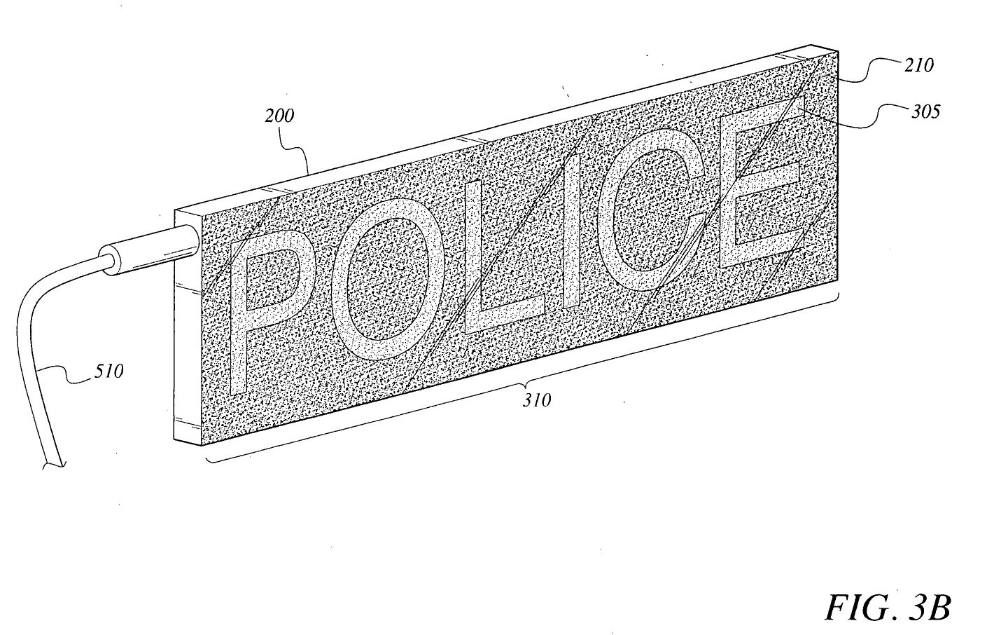

As shown in FIG. 3A, a second embodiment of the illuminated vehicle identification sign 105 comprises the aforementioned rectangular shaped EL panel 200 having a non-white printed translucent vinyl first overlay 305 adhered to the EL panel 200.

The aforementioned black opaque high performance vinyl second overlay 210 having patterned cutouts 214 and patterned fills 212 is adhered to the first overlay 305. As shown in FIG. 3B, a DC to AC inverter power source is connected to the EL panel 200. When powered up, the illuminated panel 200 in combination with overlays 305 and 210 create a lit text message 310 having the color gradation characteristics of the printed translucent vinyl overlay 305 together with a black fill color from the black overlay 210.

A manner of making the aforementioned sign 310 comprises cutting out the non-white printed translucent vinyl overlay 305 in the form of a rectangle and applying wet, centered on the EL panel 200. Excess water is squeegeed out. Next, the patterned cutouts 214 and patterned fills 212 depicting text are cut out in black vinyl to form the black vinyl overlay 210. The patterned cutouts 214 and patterned fills 212 of the overlay 210 are applied wet and centered on the non-white printed translucent vinyl overlay 305. Excess water is squeegeed out. Excess vinyl is then trimmed to edges of the EL panel 200.

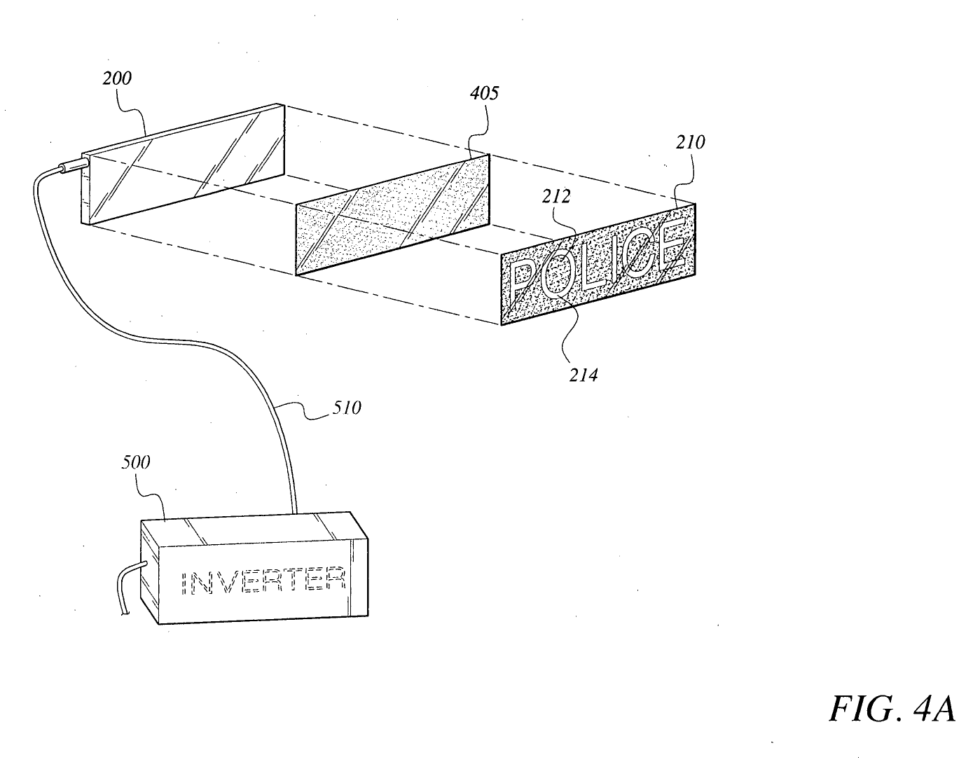

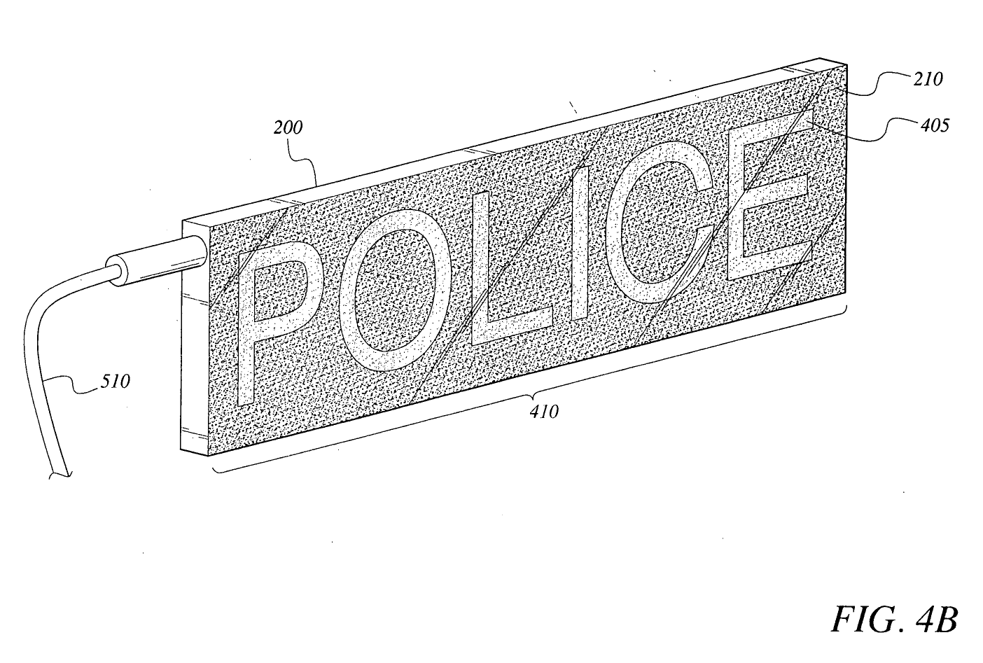

FIG. 4A shows that a third embodiment of the illuminated vehicle identification sign 105 comprises the aforementioned rectangular shaped EL panel 200 with a colored, preferably blue, translucent vinyl first overlay 405 adhered to the EL panel 200.

The aforementioned black opaque high performance vinyl second overlay 210 having patterned cutouts 214 and patterned fills 212 is adhered to the first overlay 405. The DC to AC inverter power source 500 is connected to the EL panel 200. As shown in FIG. 4B, when powered up, the illuminated panel 200 in combination with overlays 405 and 210 create a lit text message 410 having the color of the overlay 405 together with a black fill color from the black overlay 210.

A manner of making the aforementioned sign 410 comprises cutting out the non-white, preferably blue, translucent vinyl overlay 405 in the form of a rectangle and applying wet, centered on the EL panel 200. Excess water is squeegeed out. Next, the patterned cutouts 214 and patterned fills 212 depicting text are cut out in black vinyl to form the black vinyl overlay 210. The patterned cutouts 214 and patterned fills 212 of the overlay 210 are applied wet and centered on the non-white, preferably blue, translucent vinyl overlay 405. Excess water is squeegeed out. Excess vinyl is then trimmed to edges of the EL panel 200.

It is to be understood that the present invention is not limited to the embodiments described above, but encompasses any and all embodiments within the scope of the following claims.

We claim:

1. An illuminated vehicle identification sign, comprising:
an EL panel;
a white translucent vinyl first overlay adhered to the EL panel;
a black opaque high performance vinyl second overlay adhered to the white translucent vinyl, the black opaque second overlay having a plurality of patterned cutouts and patterned fills;
a plurality of blue translucent vinyl patterns depicting text adhered to the white translucent vinyl, the plurality of blue translucent vinyl patterns depicting text being disposed inside of the plurality of patterned cutouts and outside of the plurality of patterned fills, a gap being defined between the each of the blue translucent vinyl patterns and the each of the cutouts and fills; and
a dc to ac inverter power source connected to the EL panel.

2. The illuminated vehicle identification sign according to claim 1, wherein the EL panel is a light emitting capacitor type EL panel.

3. The illuminated vehicle identification sign according to claim 1, wherein the EL panel has dimensions of approximately twenty-four inches by four inches.

4. The illuminated vehicle identification sign according to claim 1, wherein the DC to AC inverter is capable of inverting an approximate 12-volt DC input having a maximum DC input current of approximately 1,200 mA to an approximately 170-volt RMS AC output having an approximate frequency of 1,200 Hz.

5. The illuminated vehicle identification sign according to claim 1, wherein the inverter power source may have on on/off flash capability of approximately two seconds on time versus one second off time.

6. The illuminated vehicle identification sign according to claim 1, wherein the inverter power source has a light dimmer control to provide an adjustment of a light intensity of the EL panel.

7. An illuminated vehicle identification sign, comprising:
an EL panel;
a non-white printed translucent vinyl first overlay adhered to the EL panel;
a black opaque high performance vinyl second overlay adhered to the non-white translucent vinyl, the black opaque second overlay having a plurality of patterned cutouts and patterned fills; and,
a dc to ac inverter power source connected to the EL panel, wherein when the power is applied to the EL panel, the resultant illumination in combination with the first and second overlays creates a lit text message having color gradation characteristics of the printed translucent vinyl overlay together with a black fill color from the black overlay.

8. The illuminated vehicle identification sign according to claim 7, wherein the EL panel is a light emitting capacitor type EL panel.

9. The illuminated vehicle identification sign according to claim 7, wherein the EL panel has dimensions of approximately twenty-four inches by four inches.

10. The illuminated vehicle identification sign according to claim 7, wherein the DC to AC inverter is capable of inverting an approximate 12-volt DC input having a maximum DC input current of approximately 1,200 mA to an approximately 170-volt RMS AC output having an approximate frequency of 1,200 Hz.

11. The illuminated vehicle identification sign according to claim 7, wherein the inverter power source may have on on/off flash capability of approximately two seconds on time versus one second off time.

12. The illuminated vehicle identification sign according to claim 7, wherein the inverter power source has a light dimmer control to provide an adjustment of a light intensity of the EL panel.

13. An illuminated vehicle identification sign, comprising:
an EL panel;
a colored translucent vinyl first overlay adhered to the EL panel;
a black opaque high performance vinyl second overlay adhered to the colored translucent vinyl, the black opaque second overlay having a plurality of patterned cutouts and patterned fills; and,
a dc to ac inverter power source connected to the EL panel, wherein when the power is applied to the EL panel, the resultant illumination in combination with the first and second overlays creates a lit text message having the color of the colored translucent vinyl overlay together with a black fill color from the black overlay.

14. The illuminated vehicle identification sign according to claim 13, wherein the EL panel is a light emitting capacitor type EL panel.

15. The illuminated vehicle identification sign according to claim 13, wherein the EL panel has dimensions of approximately twenty-four inches by four inches.

16. The illuminated vehicle identification sign according to claim 13, wherein the DC to AC inverter is capable of inverting an approximate 12-volt DC input having a maximum DC input current of approximately 1,200 mA to an approximately 170-volt RMS AC output having an approximate frequency of 1,200 Hz.

17. The illuminated vehicle identification sign according to claim 13, wherein the inverter power source may have on on/off flash capability of approximately two seconds on time versus one second off time.

18. The illuminated vehicle identification sign according to claim 13, wherein the inverter power source has a light dimmer control to provide an adjustment of a light intensity of the EL panel.
